(19) United States
(12) Patent Application Publication
(10) Pub. No.: US 2019/0281215 A1
(43) Pub. Date: Sep. 12, 2019

(54) Method for High-Quality Panorama Generation with Color, Luminance, and Sharpness Balancing

(71) Applicant: Hong Kong Applied Science and Technology Research Institute Company, Limited, Hong Kong (HK)

(72) Inventors: Chi Ho CHAN, Hong Kong (HK); Dongpeng WANG, Hong Kong (HK)

(21) Appl. No.: 15/913,752

(22) Filed: Mar. 6, 2018

(51) Int. Cl. H04N 5/232; G06T 3/40; G06T 7/90; H04N 11/20; G06T 3/00; H04N 9/64; G06T 5/00; G06T 5/20

(52) U.S. Cl. CPC H04N 5/23238; G06T 3/4038; G06T 7/90; H04N 11/20; G06T 2207/20021; H04N 9/646; G06T 5/003; G06T 5/20; G06T 3/0068

(57) ABSTRACT

Color, luminance, and sharpness balancing across images that are stitched together in a panorama compensates for exposure, alignment, and other differences between the images. Histograms counting occurrences of Y, U, and V values in overlapping regions between images are generated. The Y-value histograms are converted to Cumulative Density Functions (CDF's) and then to a Y color transfer curve which is averaged to generate a smoother averaged Y color transfer curve. Artifacts and loss of image detail caused by color transfer are suppressed by the averaging. For U and V color values the histogram bars are directly averaged using a moving average and then CDF's generated from the moving average of the histograms. Color transfer curves are generated for U and V from the CDF's for source and target images that overlap. All pixels in the source image are adjusted using the color transfer curves to perform color and luminance balancing.

### FIELD OF THE INVENTION

This invention relates to Virtual Reality (VR) panorama generation, and more particularly to color, luminance, and sharpness balancing when stitching images together.

### BACKGROUND OF THE INVENTION

In a typical Virtual Reality (VR) application, a 360-degree panoramic image or video is captured. A user wearing special goggles such as a Head-Mounted-Display (HMI)) can actively select and vary his viewpoint to get an immersive experience in a 360-degree panoramic space.

A wide variety of interesting and useful applications are possible as VR camera, technology improves and shrinks. A helmet cam such as a GoPro camera could be replaced by a VR panorama camera, set to allow the capture of 360-degree panoramas while engaging in various sports activities such as mountain biking, skiing, skydiving, traveling, etc. A VR camera placed in a hospital operating room could allow a remote surgeon or medical student to observe and interact with the operation using a VR headset or other tools. Such applications could require a very accurate rendering of the virtual space.

How the 360-degree panoramic video is captured and generated can affect the quality of the VR experience. When multiple cameras are used, regions where two adjacent camera images intersect often have visual artifacts and distortion that can mar the user experience.

FIGS. 1A-1E show problems when stitching together images to generate a panoramic image. FIG. 1A shows a prior-art VR ring camera. Ring camera 10 has multiple cameras 12 arranged in a ring. This arrangement of cameras 12 allows for a 360-degree panorama to be captured. When cameras 12 are video cameras, a panoramic video is captured. The Google Jump is an example of a VR ring camera.

In FIG. 1B, the ring camera of FIG. 1A has a ring of High-Resolution (HR) cameras 12 that generate HR images 18, each of a small arc of the full panoramic circle. HR images 18 overlap each other and details from two of HR images 18 are combined in some manner in stitch regions 19. While good image quality is obtained for most areas of HR images 18, image quality deteriorates in stitch regions 19 due to parallax and other matching errors between two of the HR cameras in the ring, resulting in image artifacts.

In FIG. 1C, cameras 12L, 12R are two adjacent cameras in ring camera 10 of FIG. 1. Object 14 is captured by both cameras 12L, 12R. However, since object 14 is a different distance and angle to each of cameras 12L, 12R, each camera 12L, 12R sees object 14 at a different location on image frame 16.

FIG. 1D, object 14 may appear on image frame 16 as two different objects 14L, 14R seen by cameras 12L, 12R. Image processing software may attempt to estimate the depth of object 14 relative to each of cameras 12L, 12R to correct the parallax error, but depth estimation is inexact and challenging. This object matching and depth estimation may result in non-linear warping of images. As FIG. 1E shows, distortion may be especially visible near interfaces where adjacent images 18L, 18R are stitched together. The test pattern is distorted at the interface between images 18L, 18R. Square boxes are squished and narrowed at the interface. This distortion is undesirable.

Image problems caused by stitching may have various causes. Exposure time and white balance may vary from image to image. Different focal lengths may be used for each camera in the ring. Some lenses may get dirty while other lenses remain clean.

FIG. 2 shows abrupt color and luminance transitions in prior-art panoramic images. Two images 120, 122 are stitched together to form part of a panoramic image. Objects in overlap region 110 between images 120, 122 are aligned well, but white balance is not well matched between images 120, 122. In particular, the sky of image 120 is noticeably darker than the sky in image 122. Perhaps the direct sunlight in image 122 caused the camera capturing image 122 to use a shorter duration of exposure than the camera capturing image 120. Perhaps because image 122 includes the sun while image 120 does not, the white balance in image 122 is adjusted for brighter sunlight than for image 120. Whatever the cause, this mis-match in white balance results in a noticeable change in the sky's darkness for image 120, and an abrupt brightening of the sky in overlap region 110 as the user pans from image 120 to image 122.

The opposite effect is seen in the foreground illumination. The brighter sky in image 122 upsets the white balance so that the plaza in the foreground is noticeably darker in region 124 than in surrounding regions 126. Abrupt transitions occur at 112, 114 between region 124 and surrounding regions 126. These abrupt transitions 112, 114 would not be visible to the human eye looking at the actual scene—they are errors created by white-balancing mismatch between adjacent captured images. These abrupt luminance transitions are undesirable.

FIG. 3 shows an abrupt sharpness transition in prior-art panoramic images. Two images 130, 132 are stitched together to form part of a panoramic image. Objects in overlap region near transition 118 between images 130, 132 are aligned well, but details are noticeably fuzzier and less sharp in image 130. The sharp details and edges of image 132 quickly transition to fuzzier edges in image 130 at transition 118 where images 130, 132 are stitched together. This abrupt sharpness transition could be caused by differences in focal length of the two cameras capturing images 130, 132, or one of the camera's lens could be dirty while the other camera's lens is clean. This sharpness transition at a stitch between images is undesirable.

FIG. 4 shows a misalignment error of a moving object in a prior-art panoramic image. The moving object (a person) is in the overlap regions of two adjacent images. Ideally, without misalignment, the object is perfectly aligned and can be viewed as a single object. However, due to misalignment, double edge 136 appears when stitching the two images together. Misalignment can cause incorrect color transfer between source and target images because the contents (overlap regions) that are used to calculate a color transfer curve are not matched. The color from an object in one image may be transferred to the adjacent image that is missing the object, causing the color-matching error. This is also undesirable.

Various prior-art techniques have been used to adjust the color, luminance, and sharpness of stitched images. The intensities of pixels are globally adjusted for color balance in an attempt to render neutral colors correctly. Color balance is a more generic term that can include gray balance, white balance, and neutral balance. Color balance changes the overall mixture of colors but is often a manual technique that requires user input.

Gamma correction is a non-linear adjustment that uses a gamma curve that defined the adjustment. User input is often required to select or adjust the gamma curve.

Histogram-based matching adjusts an image so that its histogram matches a specified histogram. Artifacts (noise) are created when a color matches to a darker reference image (the pixel is changed from a bright value to a darker value). Loss of image details occurs when a color matches to a brighter reference image (pixel is changed from dark to bright). Misalignment in overlapping regions between images can lead to incorrect color matching.

Unsharp masking uses a blurred, or “unsharp”, negative image to create a mask of the original image. The unsharped mask is then combined with the positive (original) image, creating an image that is less blurry than the original. Unsharp masking suffers because of the difficulty in choosing which parts in an image for sharpening.

FIGS. 5A-5C show image artifacts that are created by prior-art histogram-based matching that darkens pixels. In FIG. 5A, image 140 is brighter than surrounding images 142, perhaps due to a brighter white balance or a longer exposure time. In FIG. 5B, histogram-based matching is used to darken the bright pixels in image 140. However, the darker areas of image 140 may have errors or artifacts created that were not in the original image 140. FIG. 5C is an enlargement of the egg-shaped building in FIG. 5B. Artifacts 144 are created along the upper edge of the egg-shaped building where sunlight hits the building in the original image 140 of FIG. 5A. These bright-to-dark artifacts 144 are created by prior-art histogram-based matching techniques that otherwise fix the white-balance error in the foreground plaza. These bright-to-dark artifacts 144 are undesirable.

FIGS. 6A-6B show loss of image details that is created by prior-art histogram-based matching that lightens pixels. FIGS. 6A-6B show an enlargement of a horizon scene with a dark sky region. FIG. 6A shows the original image, where mountains in the background are visible although the sky is too dark. In FIG. 6B, histogram-based matching is used to lighten the bright pixels in the image. However, this overall changing of pixels from dark to bright causes the pixels for the background mountains to also become brighter. This brightening of the mountain pixels causes the mountains to partially disappear into the bright sky. The silhouette of the mountains is no longer visible between the two light poles.

Brightening the sky pixels to fix the dark sky of image 120 to better match the surrounding sky of image 122 (FIG. 2) can cause loss of detail as shown in FIG. 6B. Prior-art histogram-based matching can cause this loss of detail, especially for the brighter parts of the image. This dark-to-bright loss of detail is undesirable.

While histogram matching, white balancing, and other prior-art techniques are useful for eliminating abrupt color changes where images are stitched together in a panorama, these techniques can still produce visible artifacts, or result in a loss of image detail .

What is desired is a Virtual Reality (VR) panorama generator that reduces or eliminates artifacts or loss of detail at interfaces where images from adjacent cameras are stitched together. A panorama generator that performs white balance and sharpness adjustments at image interfaces without creating new artifacts or losing detail is desirable. A panorama generator using color, luminance, and sharpness balancing to better match stitched images is desired.

### BRIEF DESCRIPTION OF THE DRAWINGS

FIGS. 1A-1E show problems when stitching together images to generate a panoramic image.

FIG. 2 shows abrupt color and luminance transitions in prior-art panoramic images.

FIG. 3 shows an abrupt sharpness transition in prior-art panoramic images.

FIG. 4 shows a misalignment error of a moving object in a prior-art panoramic image.

FIGS. 5A-5C show image artifacts that are created by prior-art histogram-based matching that darkens pixels.

FIGS. 6A-6B show loss of image details that is created by prior-art histogram-based matching that lightens pixels.

FIG. 7 is an overall flowchart of a color and sharpness balancing method for stitching images during panorama generation.

FIG. 8 is a more detailed flowchart of the Y channel process.

FIG. 9 is a more detailed flowchart of the U, V channels process.

FIG. 10 shows an overlap region between a source image and a target image.

FIG. 11 shows histograms generated for the overlapping regions.

FIGS. 12A-12C show using graphs the Y-channel process operating on data arranged as histograms.

FIGS. 13A-13C highlight generating the Y color transfer curve and how averaging reduces both artifacts and loss of detail.

FIG. 14 highlights scaling luminance values to adjust for using an averaged Y color transfer curve.

FIGS. 15A-15C highlight the U,V-channel process that averages histograms before generating the CDF's and color transfer curves.

FIGS. 16A-16B show example graphs of the U color transfer curve with and without histogram averaging.

FIGS. 17A-17B show that averaging the Y color transfer curve does not cause dark-to-bright loss of detail.

FIGS. 18A-18C show that averaging the Y color transfer curve does not cause bright-to-dark artifacts.

FIG. 19 is a process flowchart of the sharpening process.

FIG. 20 highlights using sharpness regions across all images in a panorama.

FIGS. 21A-21B highlight image results using the multi-threshold sharpening process of FIG. 19.

FIG. 22 is a block diagram of a panorama generator that performs color, luminance, and sharpness balancing across stitched images.

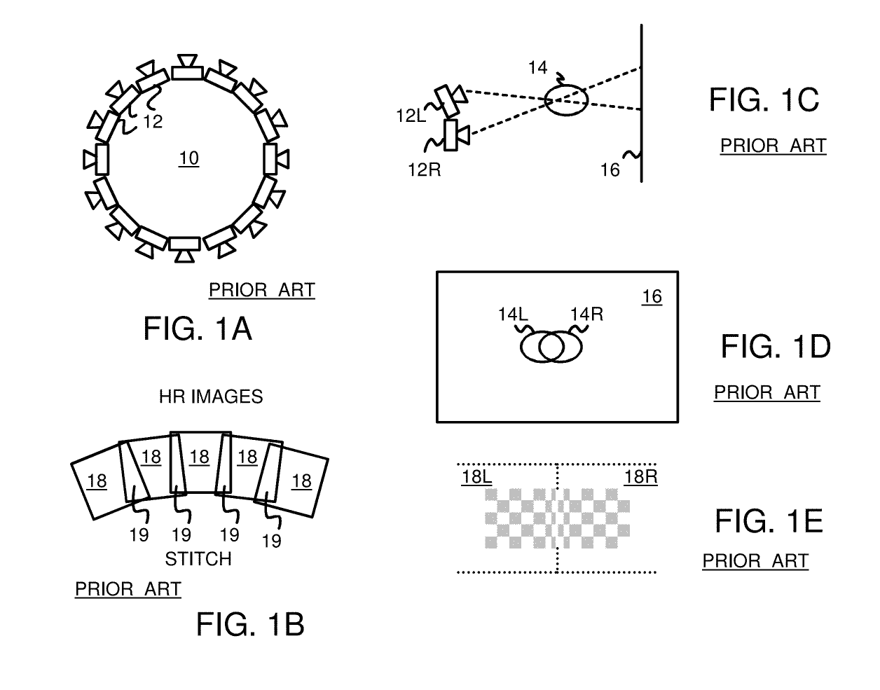

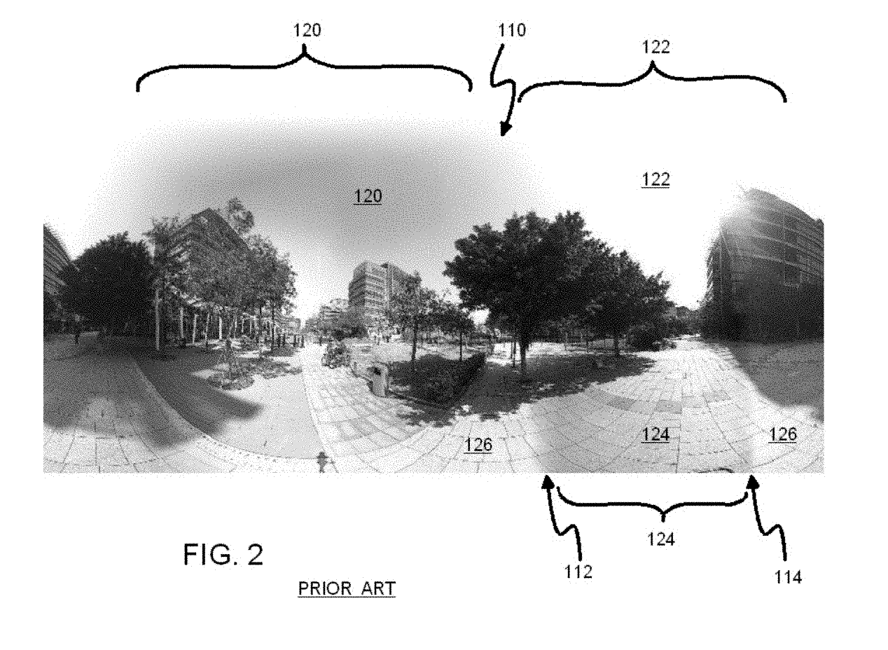

### DETAILED DESCRIPTION

The present invention relates to an improvement in stitched image correction. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

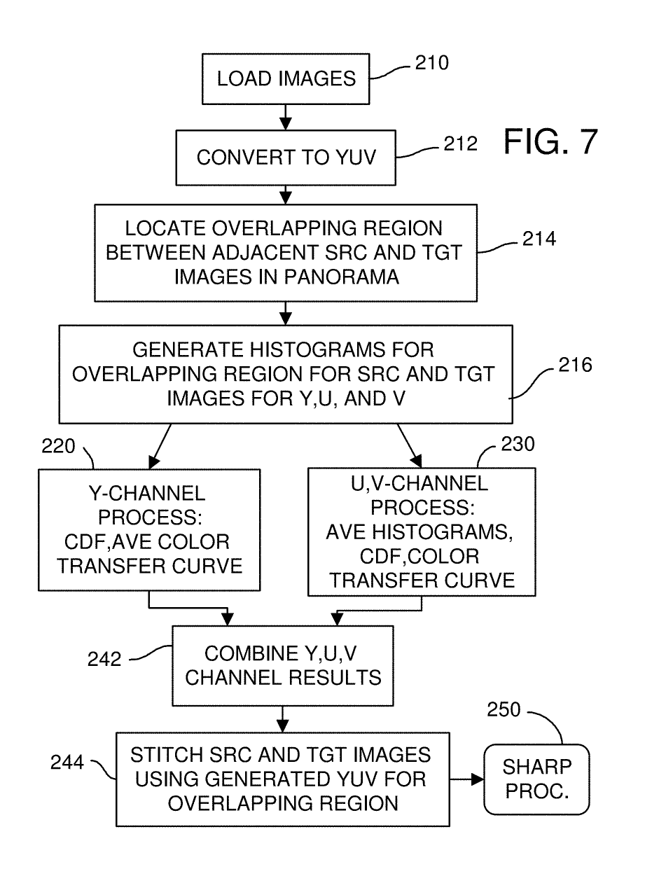

FIG. 7 is an overall flowchart of a color and sharpness balancing method for stitching images during panorama generation. Images are captured by a panorama camera that aligns adjacent images to overlap slightly. The images from the panorama camera are loaded, step 210, and converted to YUV format if in another format, such as RGB, step 212. Two of the images that are adjacent to each other are selected, one as a source image and the other as a target image. An overlapping region that is present in both the source image and in the target image is identified, step 214. The overlapping region may be predefined by a calibration process that was performed earlier.

Histograms of pixel values are generated for pixels in the overlapping region, step 216. Each histogram shows the number of occurrences within the overlapping region of a pixel value, for all possible pixel values. Thus the histogram shows the number of times each pixel value occurs. One histogram is generated for Y, another for U, and a third for V, for both the source image, and for the target image, for a total of 6 histograms. Only pixels within the overlapping region are included in the histograms.

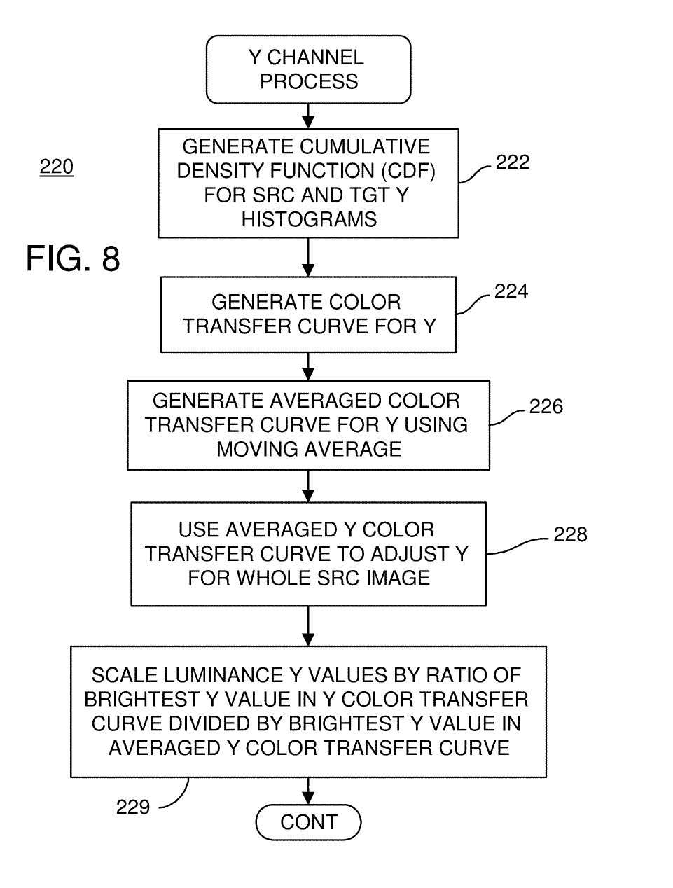

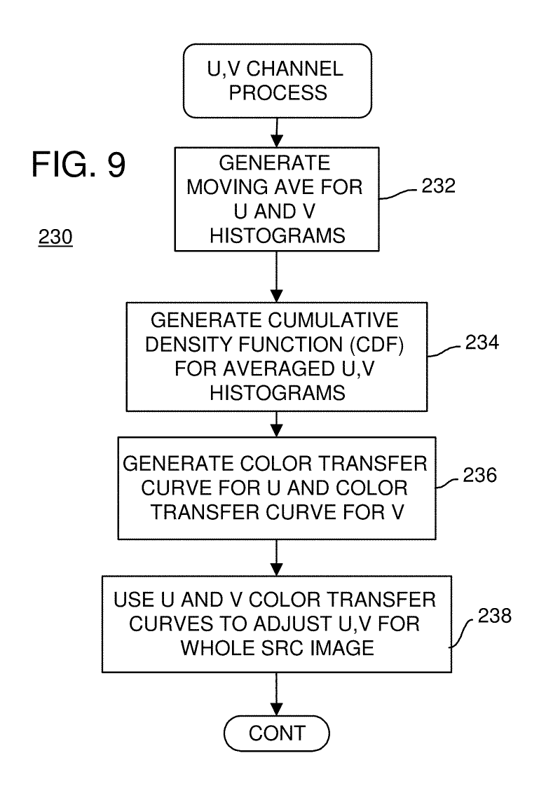

The luminance Y values are processed separately from the chrominance U and V values. Y-channel process 220, shown later in FIG. 8, generates the Cumulative Density Function (CDF) for the source and target image overlap region, generates a color transfer curve for Y, and then averages the Y transfer curve. U,V-channel process 230, shown later in FIG. 9, first averages the U and V histograms, then generates the CDFs for the source and target image overlap regions, then uses these CDF's to generate a color transfer curve for U and another color transfer curve for V. The color transfer curves are used to adjust Y, U, and V values from the source image to generate an adjusted source image with newly adjusted. YUV values.

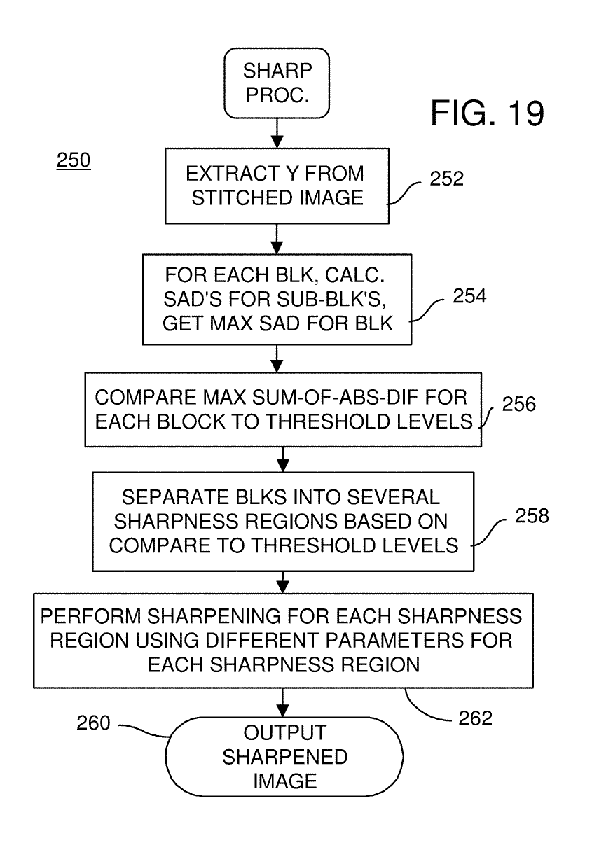

The adjusted Y, U, and V values are combined to form new YUV pixels, step 242, for the whole source image. These new YUV pixels replace the old YUV pixels in the source image. The source and target images are stitched together such as by using a blending algorithm with the new YUV values for the entire source image, including the overlapping region, step 244. Sharpening process 250 (FIG. 19) is then performed.

FIG. 8 is a more detailed flowchart, of the Y channel process. Y-channel process 220 receives the Y histogram for the source image and another Y histogram for the target image. These histograms count only pixels in the overlapping region.

The Cumulative Density Function (CDF) is generated from the Y histograms for the source and target image, step 222. The Y color transfer curve is then generated from the two CDF's, step 224. This color transfer curve is then averaged to smooth it out, generating an averaged Y color transfer curve step 226. A moving average or a sliding window can be used. Pixels from the source image are adjusted using the averaged Y color transfer curve to generate the new adjusted Y values for the whole source image, step 228. These new adjusted Y luminance values are then scaled by a ratio, step 229. The scaling ratio is the brightest Y value in the Y color transfer curve divided by the brightest Y value in the averaged Y color transfer curve. This scales the pixels up to the brightest value to compensate for any loss of brightness due to averaging.

FIG. 9 is a more detailed flowchart of the U, V channels process. U,V-channel process 230 receives the U histogram and the V histogram for the source image and another U histogram and V histogram for the target image. These four histograms count only pixels in the overlapping region.

A moving average is taken of these four histograms, step 232. The Cumulative Density Function (CDF) is generated from theses moving averages of the U and V histograms for the source and target image, step 234. The U and V color transfer curves are generated from the four CDF's, step 236. Pixels II values from the source image are adjusted using the U color transfer curve to generate the new adjusted II values for the whole source image, step 238. Likewise, pixel V values from the source image are adjusted using the V color transfer curve to generate the new adjusted V values for the whole source image, step 238

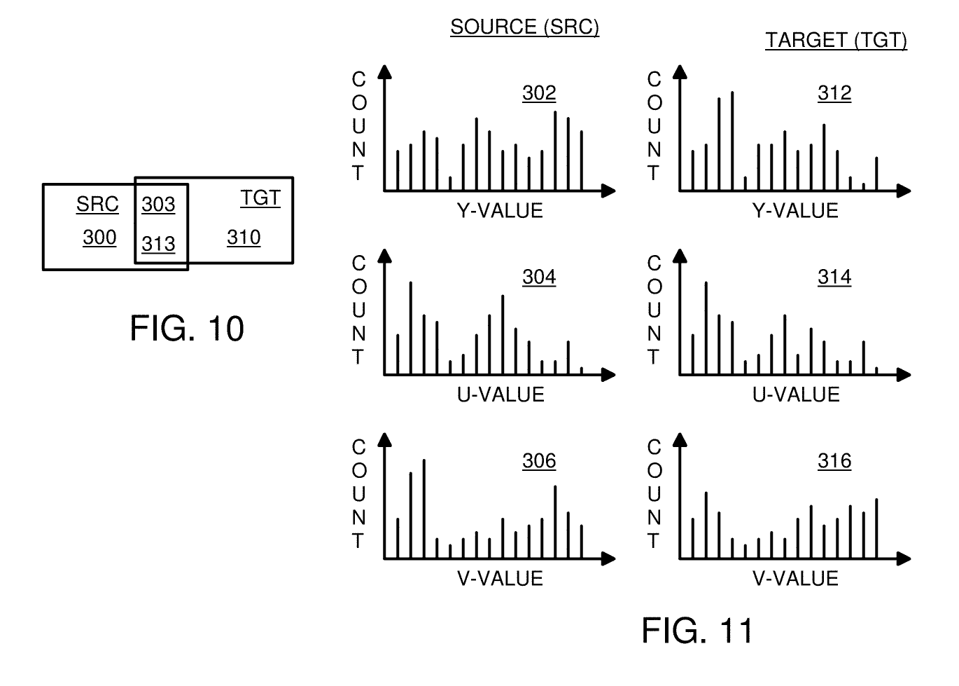

FIG. 10 shows an overlap region between a source image and a target image. Source image 300 and target image 310 overlap in source overlapping region 303 and target overlapping region 313. The process of FIGS. 7-9 is repeated, for all pairs of adjacent images in the panorama, with each successive image in the panorama being the source image one time, and the target image another time.

FIG. 11 shows histograms generated for the overlapping regions. Each histogram has a bar for each sub-pixel value that is present in the image. The height of each bar is the count of the number of pixels having that sub-pixel value within the overlapping region. Source-Y histogram 302 shows the counts of Y-values within overlapping region 303 in source image 300. Source-U histogram 304 shows the counts of U-values within overlapping region 303 in source image 300, and source-V histogram 306 shows the counts of V-values within overlapping region 303 in source image 300.

Similarly for target image 310, target-Y histogram 312 shows the counts of Y-values within overlapping region 313, target-U histogram 314 shows the counts of U-values within overlapping region 313, and target-V histogram 316 shows the counts of V-values within overlapping region 313. A total of 6 histograms are generated.

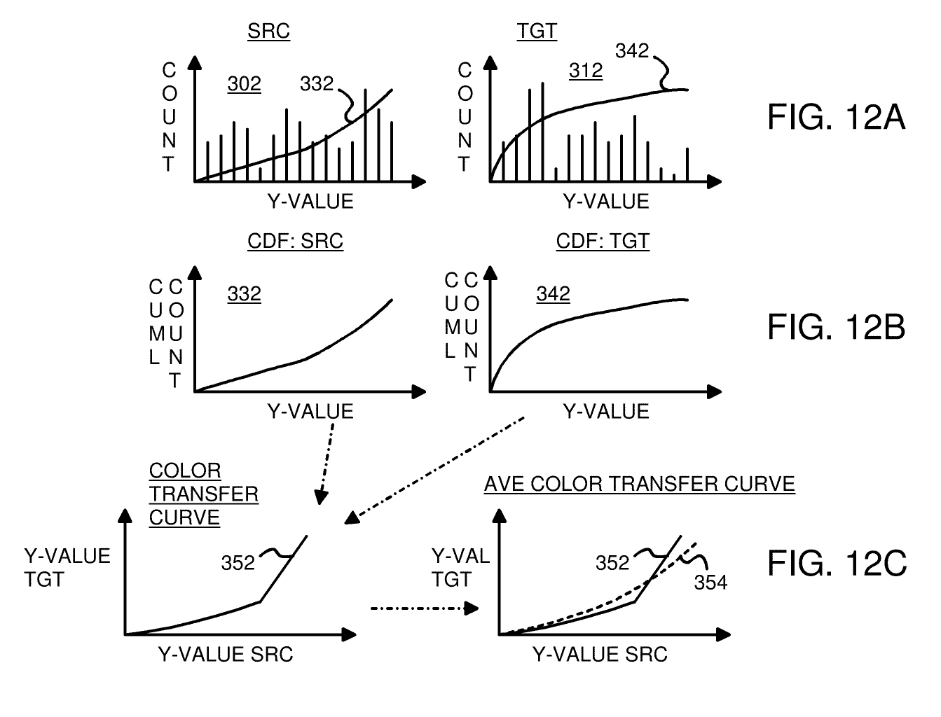

FIGS. 12A-C show using graphs the Y-channel process operating on data arranged as histograms. In FIG. 12A, source-Y histogram 302 has data about the distribution of Y values within the overlapping region of the source image. CDF curve 332 is the cumulative sum of the Y values up to that point in Source-Y histogram 302. CDF curve 332 rises for every non-zero bar in Source-Y histogram 302 from the smallest Y value on the left to the largest Y value on the right. Larger bars cause CDF curve 332 to increase by a larger amount. CDF curve 342 for target-Y histogram 312 is formed in a similar way, but using data from the target image overlapping region.

In FIG. 12B, source CDF curve 332 is shown without the histogram bars. The shape of CDF curve 332 rises slowly at first, then rises more quickly. This bent curve shape is caused by the source image having more high Y-value (bright) pixels than low-value (dark) pixels in the overlapping region.

Also, in FIG. 12B, target CDF curve 342 is shown without the histogram bars. The shape of target CDF curve 342 rises rapidly at first, then flattens out and rises more slowly. s flattening curve shape is caused by the target image having more low Y-value (dark) pixels than high-value (bright) pixels in the overlapping region, as seen in target-Y histogram 312 (FIG. 121).

In FIG. 12C, source CDF curve 332 and target CDF curve 342 are combined to generate Y color transfer curve 352. The source Y value and the target Y value that produce the same cumulative count are matched together and plotted as Y color transfer curve 352.

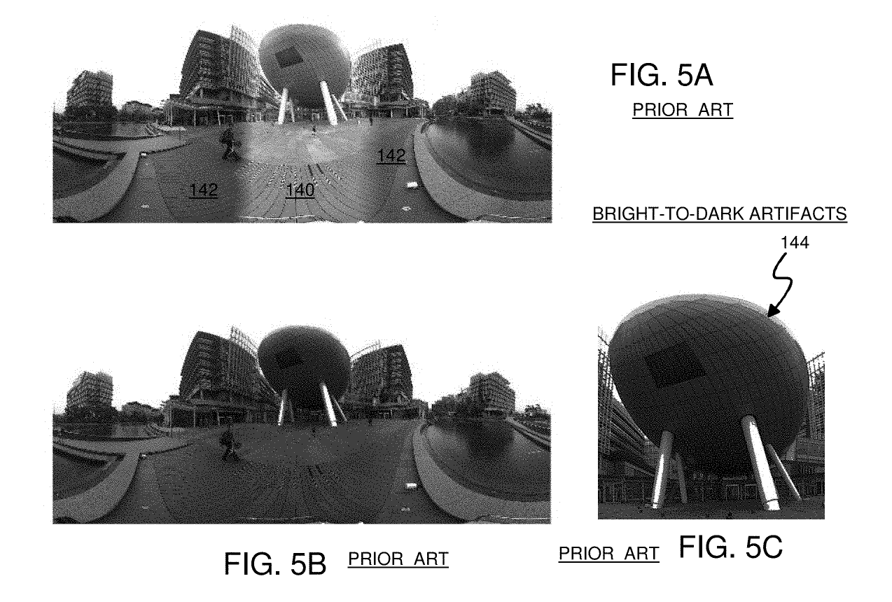

This Y color transfer curve 352 could be looked up using the source Y values to get the new adjusted source Y values. However, the inventors have noticed that there can be abrupt changes in the slope of Y color transfer curve 352, and the inventors believe that these abrupt slope changes cause artifacts such as shown in FIG. 5. Instead, the inventors use a moving average to smooth out Y color transfer curve 352 to generate averaged Y color transfer curve 354.

When Y values for pixels in the source image are adjusted, averaged Y color transfer curve 354 is used rather than Y color transfer curve 352. Using averaged Y color transfer curve 354 produces fewer artifacts because the rate of change of averaged Y color transfer curve 354 is less than for Y color transfer curve 352 due to the averaging.

Surprisingly, averaging p eliminate both the artifacts problem and the loss of detail problems. Even though artifacts and loss of detail occur at opposite extremes, they are both solved by averaging, which reduces extremes.

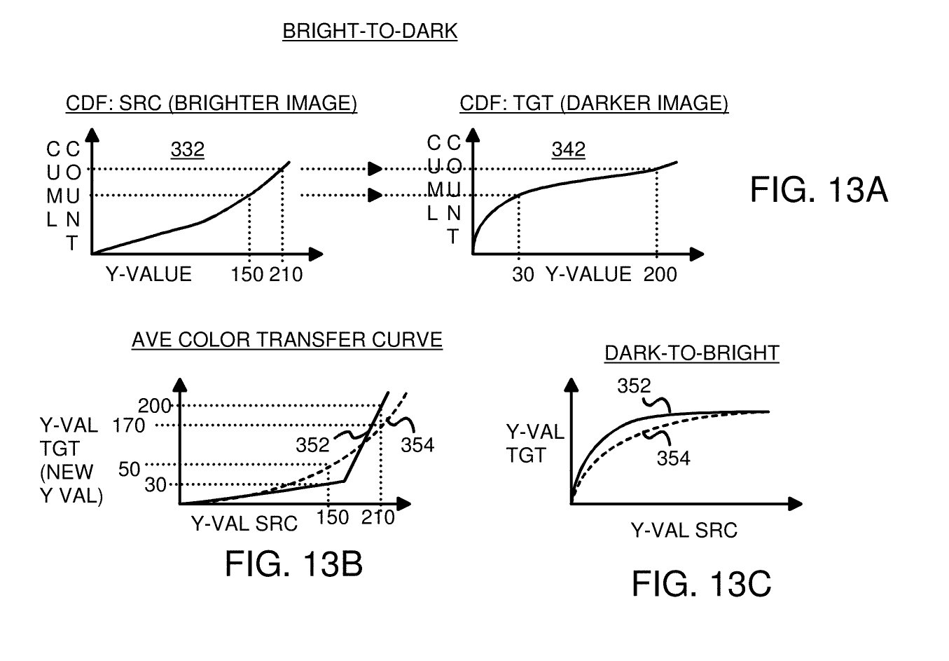

FIGS. 13A-13C highlight generating the Y color transfer curve and how averaging reduces both artifacts and loss of detail.

In FIG. 13A, source CDF curve 332 and target CDF curve 342 are combined. Each cumulative count value only occurs once in each graph. For each cumulative count value, the source Y value from source CDF curve 332 and the target Y value from target CDF curve 342 are extracted and combined into a pair.

For example, a large cumulative count value intersects source CDF curve 332 at a Y-value of 210. This same large cumulative count value intersects target CDF curve 342 at a Y-value of 200. See the upper dashed line that intersects both source CDF curve 332 and target CDF curve 342. Thus one (source, target) pair is (210, 200).

Another, smaller cumulative count value intersects source CDF curve 332 at a Y-value of 150. This same smaller cumulative count value intersects target CDF curve 342 at a Y-value of 30. See the lower dashed line that intersects both source CDF curve 332 and target CDF curve 342. Thus another (source, target) pair is (150,30).

Many others of these (source, target) pairs are extracted in a similar fashion for all the other cumulative count values. These (source, target) pairs are then plotted as shown in FIG. 13B as Y color transfer curve 352, where the x-axis is the source Y value and the y-axis is the target Y-value for each pair.

FIG. 13B shows that (source, target) pair (210, 200) intersects Y color transfer curve 352, as does pair (150,30). However, when Y color transfer curve 352 is averaged to generate averaged Y color transfer curve 354, different pairs are obtained. Source Y value 210 intersects averaged Y color transfer curve 354 at 170 rather than at 200, so pair (210, 200) is averaged to (210,170). Likewise, source Y value 150 intersects averaged Y color transfer curve 354 at 50 rather than at 30, so pair (150,30) is averaged to (150,50).

Using averaged Y color transfer curve 354 rather than Y color transfer curve 352 causes the new adjusted Y values to be less extreme. Instead of 200, 170 is used, and instead of 30, 50 is used. Using Y color transfer curve 352, the difference in Y values in the source image is 200-30 or 170, while using averaged Y color transfer curve 354 the Y value difference is 170-50 or 120. Since 120 is less than 170, any spurious artifacts should be reduced. These less extreme Y values can reduce artifacts.

When performing color transfer, all pixels in the source image having a Y value of 210 are converted to new Y values of 170, using averaged Y color transfer curve 354. Likewise, all pixels in the source image having a Y value of 150 are converted to new Y values of 50. Any Y value in the source image can be looked up using averaged Y color transfer curve 354 to find the new Y value.

When the source image is bright, such as shown for source-Y histogram 302, and target image is dark, such as shown for target-Y histogram 312, (FIG. 12C) the shape of Y color transfer curve 352 will be concave upward with the obvious bending in the middle as shown in FIG. 12C and FIG. 13B. The obvious bending means that brightness values are changing abruptly, which can cause artifacts to be created.

Alternately, when the source image is dark and target image is bright, (FIG. 13C) the shape of color transfer curve will be convex with a flat region. The flat region means that the brightness values change very little and are possibly saturated. Saturation causes loss of image detail.

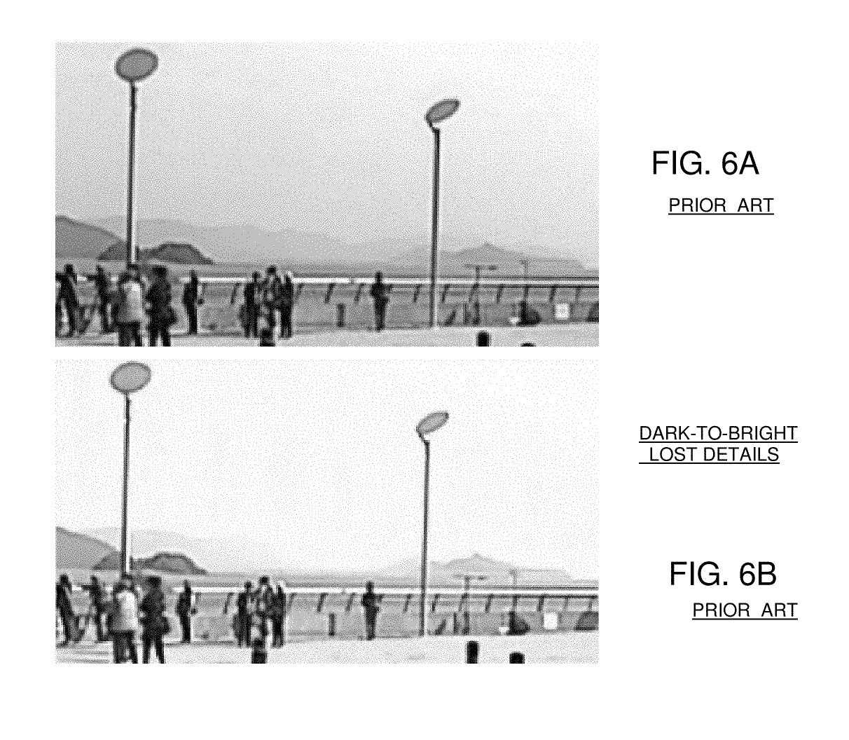

Averaging Y color transfer curve 352 to generate averaged Y color transfer curve 354 causes the shape to be smoothed out, reducing any bending that might cause the dark-to-bright artifacts to be generated (FIG. 13B). Averaging also causes the flat saturation region of Y color transfer curve 352 in FIG. 13C to become less flat, as and more sloped, as shown by averaged Y color transfer curve 354. This increase of slope in the flat saturation region reduces the loss of detail problem. Thus averaging Y color transfer curve 352 and using averaged. Y color transfer curve 354 can both reduce artifacts (FIG. 5, 18) and reduce loss of detail (FIG. 6, 17).

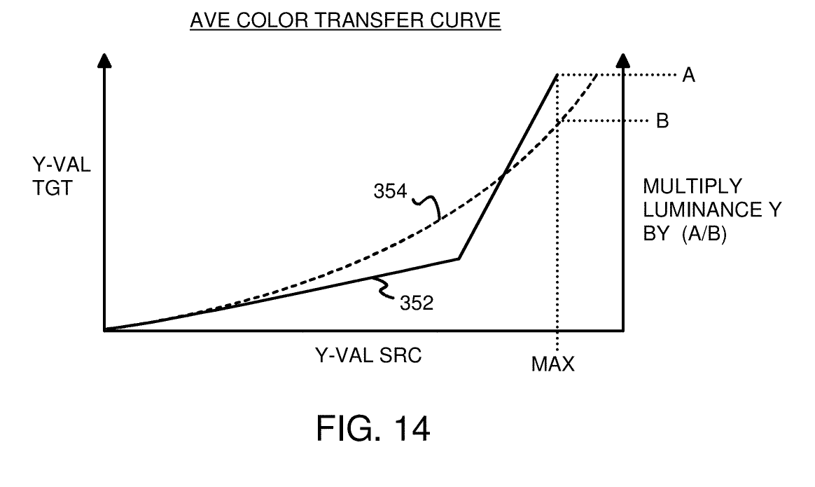

FIG. 14 highlights scaling luminance values to adjust for using an averaged Y color transfer curve. Step 229 of FIG. 8 is shown graphically in FIG. 14.

As seen in the graph of FIG. 14, averaged Y color transfer curve 354 is smoother than Y color transfer curve 352, and the abrupt change in Y color transfer curve 352 is eliminated using averaged Y color transfer curve 354. The abrupt change in Y color transfer curve 352 is thought by the inventors to cause artifacts when brighter source pixels are adjusted to darker pixels.

The maximum Y value MAX is 235 for some YUV pixel encodings. This maximum Y value MAX intersects Y color transfer curve 352 at point A. However, when averaged Y color transfer curve 354 is used, this maximum Y value MAX intersects averaged Y color transfer curve 354 at a smaller value B. Since B is smaller than A, using averaged Y color transfer curve 354 does not fully expand Y values to the full Y range of 0 to 235. This is undesirable, since saturated objects such as clouds in the sky may have the same saturated value for all images for better matching.

To compensate for the reduction of luminance range due to averaging, the new adjusted Y luminance values are scaled by a ratio of A/B. The scaling ratio is the brightest Y value in the Y color transfer curve divided by the brightest Y value in the averaged Y color transfer curve. This scales the pixels up to the brightest value to compensate for any loss of brightness due to averaging.

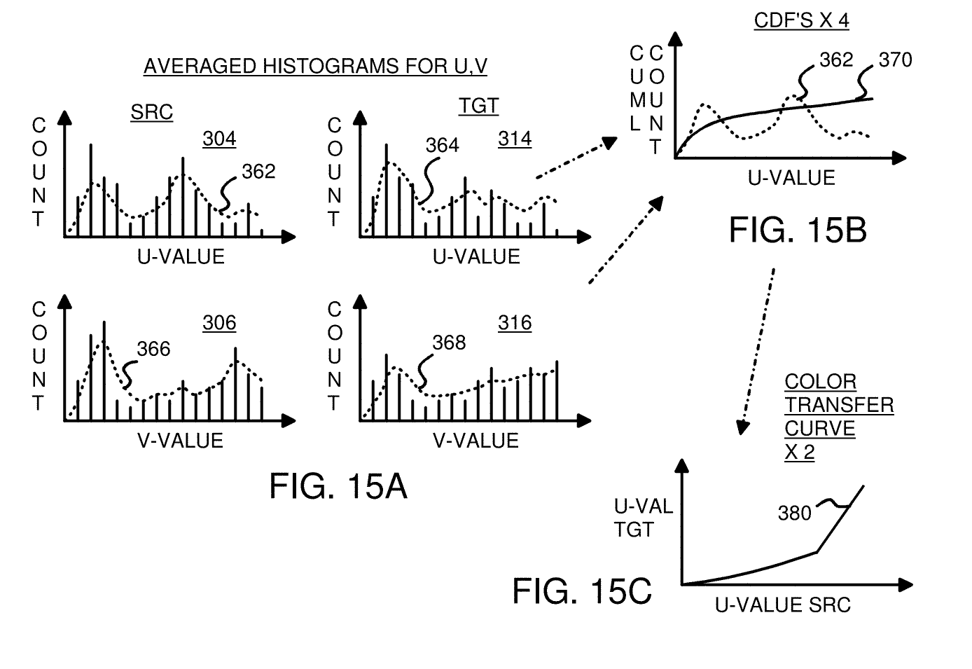

FIGS. 15A-15C highlight the U,V-channel process that averages histograms before generating the CDF's and color transfer curves. U,V-channel process 230 (FIG. 9) differs from Y-channel process 220 (FIG. 8) because the Y-process generates CDF's and Y color transfer curve 352 before averaging, while the U, V process averages histograms and then generates the CDF and color transfer curves. Y-channel process 220 performs color-transfer-curve averaging while UN-channel process 230 performs histogram averaging.

Using this process, adjacent color values tend to have similar color counts (histogram bar heights). Also, color distribution is more even when averaging is performed on histograms. This reduces the introduction of extra color that might be caused by misalignment

In FIG. 15A, source-U histogram 304 has data about the distribution of U values within the overlapping region of the source image. A moving average of these histogram bars is generated and shown on the graph as averaged source-U histogram 362. Similarly, source-V histogram 306 has averaged source-V histogram 366 superimposed.

Target-U histogram 314 has averaged target-U histogram 364 superimposed, while target-V histogram 316 has averaged target-V histogram 368 superimposed. A shorter moving average can be used to make these averaged histograms more responsive, compared to the longer moving average used for generating averaged Y color transfer curve 354 (FIG. 12C).

In FIG. 15B, a Cumulative Density Function (CDF) is generated for each of the four averaged histograms of FIG. 15A. FIG. 15B shows only one of the four CDF's. The cumulative count of averaged source-U histogram 362 is taken rather than the cumulative count of the histogram bars of Source-U histogram 304 to generate source-U CDF 370.

In FIG. 15C, source-U CDF 370 and the target-U CDF (not shown) are combined to create U color transfer curve 380. The process for combining the source and target U CDF's is similar to that for combining the source and target Y CDF's shown in FIG. 13A, where pairs of source-U and target-U values are created that have the same cumulative count. The pairs are then plotted as U color transfer curve 380 with the x-axis being the source U value and the y-axis being the target U value.

A similar process is used for the V values to combine source-V CDF (not shown) and the target-V CDF (not shown) to create the V color transfer curve (not shown).

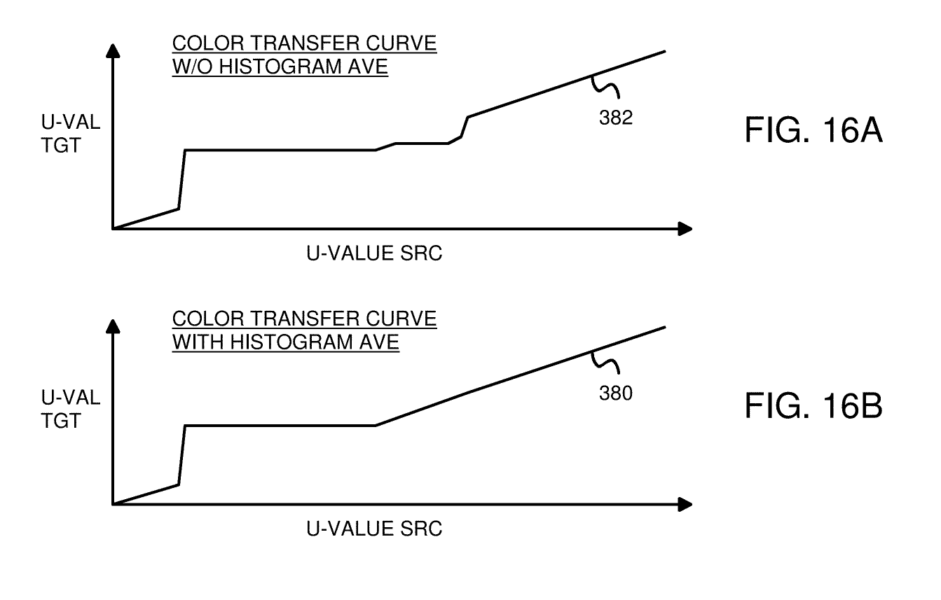

FIGS. 16A-16B show example graphs of the U color transfer curve with and without histogram averaging.

Without histogram averaging, step 232 of FIG. 9 is skipped. CDF's are generated from the histogram bars rather than from averaged histograms such as averaged source-U histogram 362. In FIG. 16A, histogram averaging is skipped. U color transfer curve 382 has irregularities in the middle portion. These irregularities may cause disturbances in color such as uneven color or sudden color change that is not in the original images before being stitched together.

With histogram averaging, FIG. 16B has a more regular shape to U color transfer curve 380. The irregularities in the middle of U color transfer curve 382 of FIG. 16A are absent. Averaging of the histogram values before CDF and U color transfer curve 380 generation produces a better curve with fewer irregularities. When the irregularities are related to skin color in a video sequence, the frame-to-frame misalignment may cause skin color changes if averaging is not used.

Using a color transfer curve generated with histogram averaging can minimize incorrect color matching due to mismatch of image contents in the overlapping regions (misalignment errors).

Since the human eye is more sensitive to brightness (Y) than to color (U,V), abrupt changes in U color transfer curve 380 do not create visible U,V artifacts.

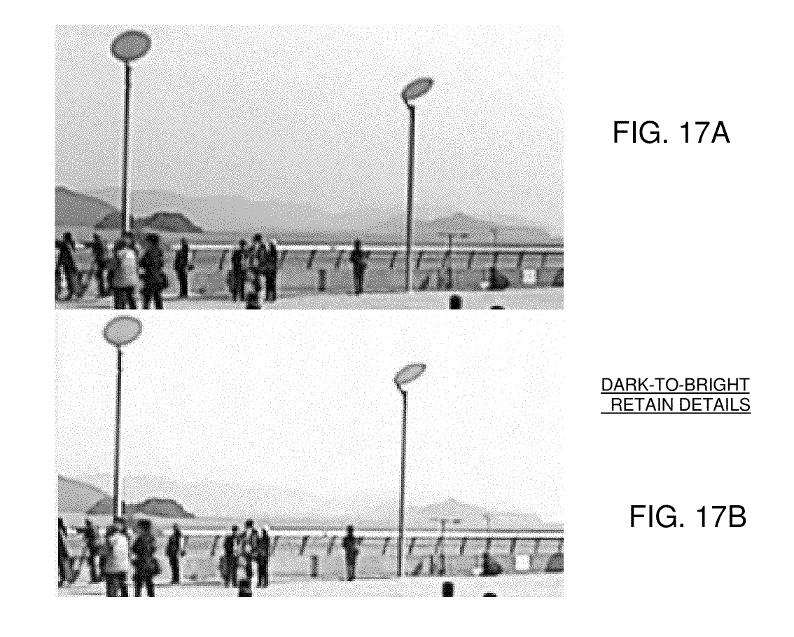

FIGS. 17A-17B show that averaging the Y color transfer curve does not cause dark-to-bright loss of detail. FIG. 17A is the same original image as in FIG. 6A. However, after using averaged Y color transfer curve 354 rather than Y color transfer curve 352 in the process flow of FIGS. 7-8, image details such as the silhouette of the mountains in the background are retained, as shown in FIG. 17B. These details were lost in the prior-art image of FIG. 6B that did not use averaging. Thus averaging of the Y color transfer curve prevents loss of image detail for pixels that are increased in Y, or brightened by the balancing process. These dark-to-bright pixels are not saturated into the background image.

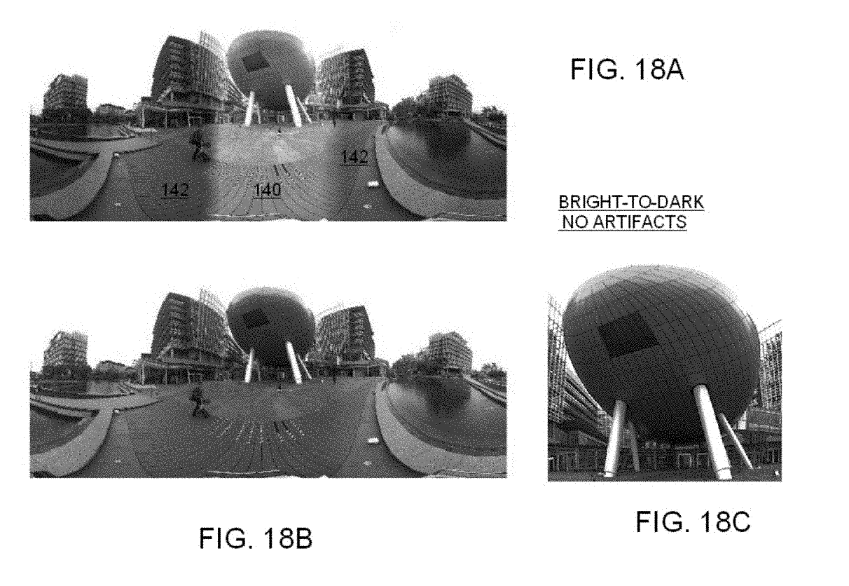

FIGS. 18A-18C show that averaging the Y color transfer curve does not cause bright-to-dark artifacts. FIG. 18A is the same original image as in FIG. 5A. Dark and bright regions are balanced using the process flow of FIGS. 7-8. Since averaged Y color transfer curve 354 is used rather than Y color transfer curve 352, additional artifacts are not generated, as shown in FIG. 18B. In particular, the sunlight upper edges of the egg-shaped building that are shown enlarged in FIG. 18C do not have dark blocky artifacts that were visible in prior-art FIG. 5C when a prior-art histogram matching process was used.

Thus averaging of the Y color transfer curve prevents the creation of dark artifacts for pixels that are decreased in Y, or darkened by the balancing process. These bright-to-dark pixels do not create artifacts. Averaging Y color transfer curve 352 to use averaged Y color transfer curve 354 can both reduce artifacts (FIGS. 5, 18) and reduce loss of detail (FIGS. 6, 17).

FIG. 19 is a process flowchart of the sharpening process. Sharpening process 250 is a sharpness balancing process that is executed after Y-channel process 220 and U,V-channel process 230 complete color balancing and the Y values have been scaled to compensate for averaging the Y color transfer curve. The images have been stitched together into a single panoramic image space (FIG. 7, step 244).

The Y values are extracted from the panorama of stitched images, step 252. The entire panoramic image space is divided into blocks. Each block is further sub-divided into sub-blocks. For example, 16×16 blocks can be subdivided into 81 8×8 sub-blocks, or and 8×8 block can be sub-divided into 25 4×4 sub-blocks, or a 4×4 block could be sub-divided into nine 2×2 blocks. Just one sub-block size may be used for the whole panorama.

The sum-of-the-absolute difference (SAD) of the Y values is generated for each sub-block in each block, and the maximum of these SAD results (MAX SAD) is taken for each block, step 254. The MAX SAD value indicates the maximum difference among pixels within any one sub-block in the block. A block having a sub-block with a large pixel difference can occur when an edge of some visual object passes through the sub-block. Thus larger MAX SAD values indicate sharp features.

The MAX SAD value is used for the entire block. The MAX SAD value may be divided by 235 and then divided by 4 to normalize it to the 0 to 1 range. The MAX SAD value for each block is compared to one or more threshold levels, step 256. Blocks are separated into two or more sharpness regions, based on the threshold comparison, step 258. Sharpening is performed for all blocks in a sharpness region using a same set of sharpening parameters, regardless of which original image the block was extracted from. Different sharpness regions may use different parameters to control the sharpening process, step 262. The sharpened Y values over-write the Y values of the YUV pixels, and the image is output for the entire panorama, step 260.

For example, when there are two thresholds, blocks may be divided into three sharpness regions, such as sharp, blurry, and more blurry. These regions can span all images in the panorama, so sharpness is processed for the entire panorama space, not for individual images. This produces a more uniform panorama without abrupt changes in sharpness between images that are stitched together.

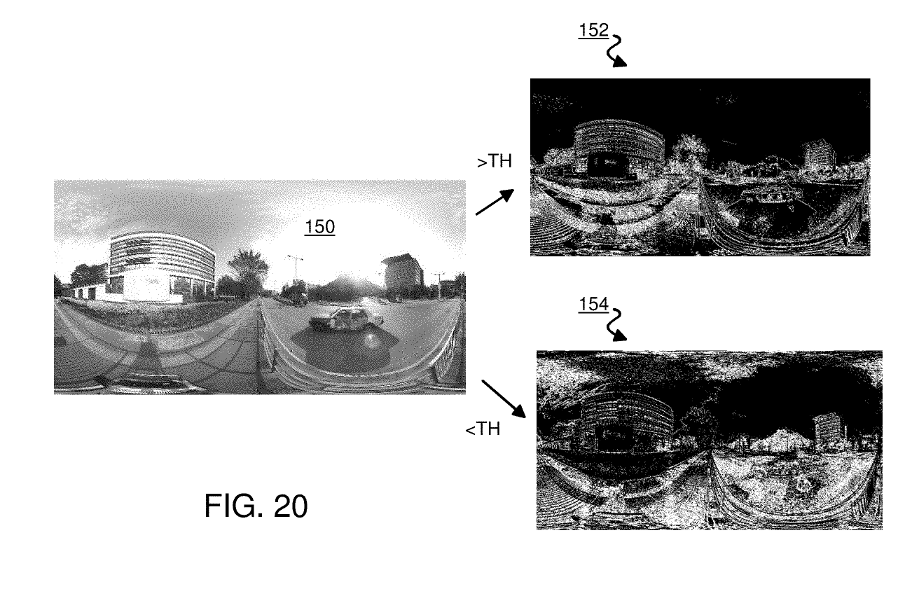

FIG. 20 highlights using sharpness regions across all images in a panorama. Stitched panorama 150 contains two or more images that are stitched together. Blocks with a MAX SAD above a threshold >TH are grouped into upper sharpness region 152, while blocks from stitched panorama 150 with a MAX SAD below the threshold <TH are grouped into lower sharpness region 154. The sharp edges of the building appear as white areas in upper sharpness region 152, while the flat pavement areas around the car in the lower right foreground appear as white blocks in lower sharpness region 154.

Blocks in upper sharpness region. 152 can be processed with sharpening parameters that sharpen edges, while blocks in lower sharpness region 154 can be processed with other sharpening parameters that sharpen the white region. Thus the buildings are sharpened to a particular level, while the road pavement is sharpened to another level. This approach is intended to balance the sharpness of a whole panorama with different levels of sharpness regions. Since the sharpness region span multiple stitched images, sharpening is consistent across all stitched images in the panorama.

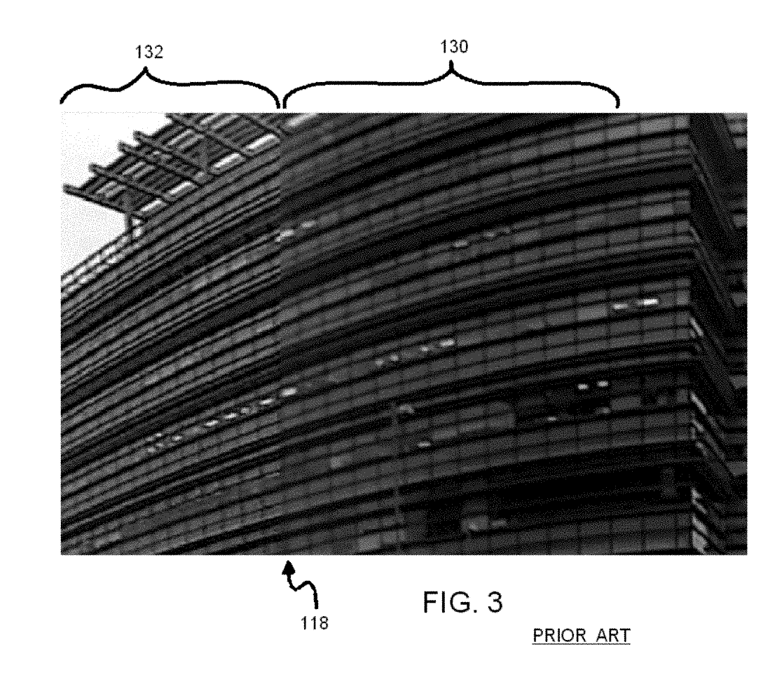

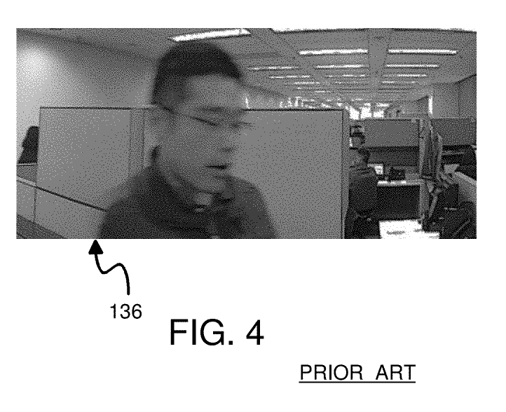

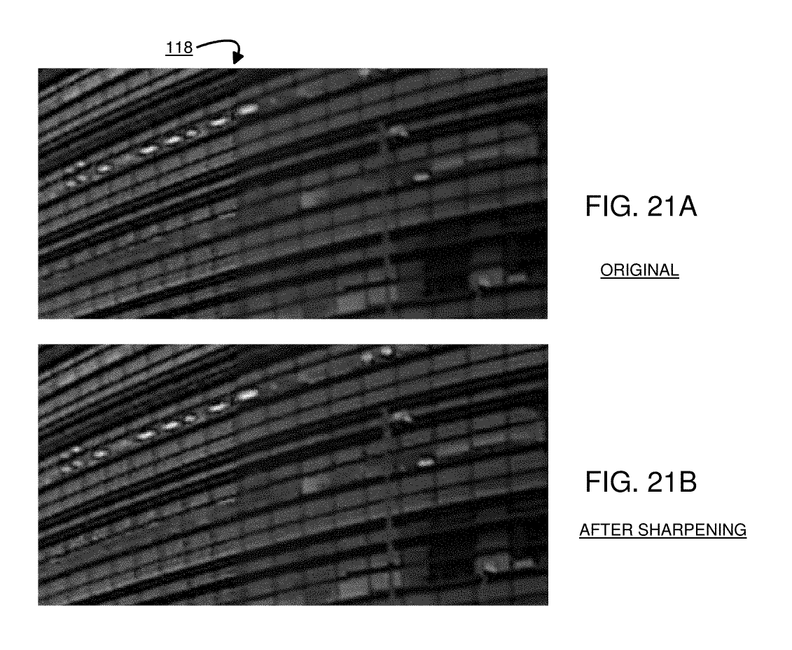

FIGS. 21A-21B highlight image results using the multi-threshold sharpening process of FIG. 19. FIG. 21A is the original stitched image from FIG. 3 before any sharpness balancing is performed. Objects in overlap region of transition 118 between two stitched images are aligned well, but details are noticeably fuzzier and less sharp in the right-side image. The sharp details and edges of the left image quickly transition to fuzzier edges in the right image at transition 118 where the images are stitched together.

FIG. 21B, after sharpness processing using sharpening process 250, sharpness has notably improved in the right image. Transition 118, while still just barely visible, is much less noticeable.

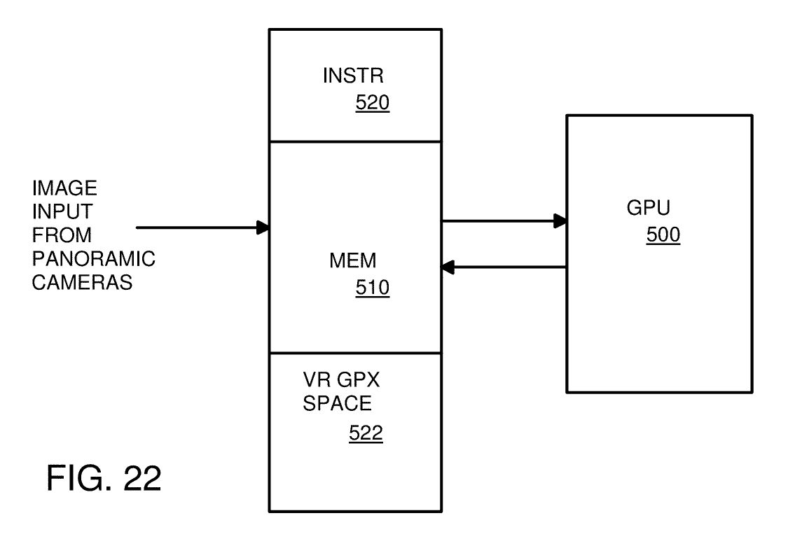

FIG. 22 is a block diagram of a panorama generator that performs color, luminance, and sharpness balancing across stitched images. Graphics Processing Unit (GPU) 500 is a microprocessor that has graphics-process enhancements such as a graphics pipeline to process pixels. GPU 500 executes instructions 520 stored in memory to perform the operations of the process flowcharts FIGS. 7-9, and 19. Pixel values from source and target images are input to memory 510 for processing by GM 500, which stitches these images together and writes pixel values to VR graphics space 522 in the memory. Other VR applications can access the panorama image stored in VR graphics space 522 for display to a user such as in a Head-Mounted-Display (HMD).

### ALTERNATE EMBODIMENTS

Several other embodiments are contemplated by the inventors. For example, additional functions and step could be added, and some steps could be performed simultaneously with other steps, such as in a pipeline, or could be executed in a re-arranged order. For example, adjusting the overall luminance by scaling Y values (FIG. 8, step 229) could be performed before the adjusted Y values are re-combined with the adjusted U,V values (FIG. 7 step 242), or after combining.

While a single panorama image space that is generated by stitching together images has been described, the images could be part of a sequence of images, such as for a video, and a sequence of panoramic images could be generated for different points in time. The panoramic space could thus change over time.

While YUV pixels have been described, other formats for pixels could be accepted and converted into YUV format. The YUV format itself may have different bit encodings and bit widths (8, 16, etc.) for its sub-layers (Y, U, V), and the definitions and physical mappings of Y, U, and V to the luminosity and color may vary. Other formats such as RGB, CMYK, HSL/HSV, etc. could be used. The term YUV is not restricted to any particular standard but can encompass any format that uses one sub-layer (Y) to represent the brightness, regardless of color, and two other sub-layers (U,V) that represent the color space.

The number of Y value data points that are averaged when generating averaged Y color transfer curve 354 can be adjusted. More data points being averaged together produces a smoother curve for averaged Y color transfer curve 354, while fewer Y data pints in the moving average provides a more responsive curve that more closely follows Y color transfer curve 352. For example, when Y is in the range of 0 to 235, a moving average of 101 Y data values can be used. The moving average can contain data values from either or both sides of the current data value, and the ratio of left and right side data points can vary, or only data points to one side of the current data value may be used, such as only earlier data points. Extra data points for padding may be added, such as Y values of 0 at the beginning of the curve, and 235 at the end of the curve.

Likewise, the number of histogram bars that are averaged by the moving average that generates averaged U histogram 362 and other U, V chroma histograms can be varied. The moving average parameter or window size can be the same for all histograms or for all histograms and for averaged Y color transfer curve 354, or can be different. In one example, a moving average of 5 histogram bars is used with 2 padded values at the beginning and 2 padded values at the end.

The number of sharpness thresholds can be just one, or can be two or more for multi-thresholding. The amount of sharpening can vary from region to region, and can be adjusted based on the application, or for other reasons. Many different parameter values can be used.

Various resolutions could be used, such as HD, 4K, etc., and pixels and sub-layers could be encoded and decoded in a variety of ways with different formats, bit widths, etc. Additional masks could be used, such as for facial recognition, image or object tracking, etc.

While images show errors such as bright-to-dark artifacts and loss of detail have been shown, the appearance of errors may vary greatly with the image itself, as well as with the processing methods, including any pre-processing. Such images that are included in the drawings are merely to better understand the problems involved and how the inventors solve those problems and are not meant to be limiting or to define the

Color pixels could be converted to gray scale for searching in search windows with a query patch. Color systems could be converted during pre or post processing, such as between YUV and RGB, or between pixels having different bits per pixel. Various pixel encodings could be used, and frame headers and audio tracks could be added. GPS data or camera orientation data could also be captured and attached to the video stream.

While sum-of-the-absolute difference (SAD) has been described, other methods may be used, such as Mean-Square-Error (MSE), Mean-Absolute-Difference (MAD), Sum-of-Squared Errors, etc. Rather than use macroblocks, smaller blocks may be used, especially around object boundaries, or larger blocks could be used for background or objects. Regions that are not block shaped may also be operated upon.

When used in various processes, the size of the macroblock may be 8×8, 16×16, or some other number of pixels. While macroblocks such as 16×16 blocks and 8×8 have been described, other block sizes can be substitutes, such as larger 32×32 blocks, 16×8 blocks, smaller 4×4 blocks, etc. Non-square blocks can be used, and other shapes of regions such as triangles, circles, ellipses, hexagons, etc., can be used as a patch region or “block”. Adaptive patches and blocks need not be restricted to a predetermined geometrical shape. For example, the sub-blocks could correspond to content-dependent sub-objects within the object. Smaller block sizes can be used for very small objects.

The size, format, and type of pixels may vary, such as RGB, YUV, 8-bit, 16-bit, or may include other effects such as texture or blinking. When detecting overlapping regions from source and target images, a search range of a query patch in the search window may be fixed or variable and may have an increment of one pixel in each direction, or may increment in 2 or more pixels or may have directional biases. Adaptive routines may also be used. Larger block sizes may be used in some regions, while smaller block sizes are used near object boundaries or in regions with a high level of detail.

The number of images that are stitched together to form a panorama may vary with different applications and camera systems, and the relative size of the overlap regions could vary. Panoramic images and spaces could be 360-degree, or could be spherical or hemi-spherical, or could be less than a full 360-degree wrap-around, or could have image pieces missing for various reasons. The shapes and other features of curves and histograms can vary greatly with the image itself.

Graphs, curves, tables, and histograms are visual representations of data sets that may be stored in a variety of ways and formats, but such graphic representations are useful for understanding the data sets and operations performed. The actual hardware may store the data in various ways that do not at first appear to be the graph, curve, or histograms, but nevertheless are alternative representations of the data. For example, a linked list may be used to store the histogram data for each bar, and (source, target) pairs may also be stored in various list formats that still allow the graphs to be re-created for human analysis, while being in a format that is more useful for reading by a machine. A table could be used for averaged Y color transfer curve 354. The table has entries that are looked up by the source Y value, and the table entry is read to generate the new Y value. The table or linked list is an equivalent of averaged Y color transfer curve 354, and likewise tables or linked lists could be used to represent the histograms, etc.

Various combinations of hardware, programmable processors, software, and firmware may be used to implement functions and blocks. Pipelining may be used, as may parallel processing. Various routines and methods may be used, and factors such as the search range and block size may also vary.

It is not necessary to fully process all blocks in each time-frame. For example, only a subset or limited area of each image could be processed. It may be known in advance that a moving object only appears in a certain area of the panoramic frame, such as a moving car only appearing on the right side of a panorama captured by a camera that has a highway on the right but a building on the left. The “frame” may be only a subset of the still image captured by a camera or stored or transmitted,

The background of the invention section may contain background information about the problem or environment of the invention rather than describe prior art by others. Thus inclusion of material in the background section is not an admission of prior art by the Applicant.

Any methods or processes described herein are machine-implemented or computer-implemented and are intended to be performed by machine, computer, or other device and are not intended to be performed solely by humans without such machine assistance. Tangible results generated may include reports or other machine-generated displays on display devices such as computer monitors, projection devices, audio-generating devices, and related media devices, and may include hardcopy printouts that are also machine-generated. Computer control of other machines is another tangible result.

Any advantages and benefits described may not apply to all embodiments of the invention. When the word “means” is recited in a claim element, Applicant intends for the claim element to fall under 35 USC Sect. 112, paragraph 6. Often a label of one or more words precedes the word “means”. The word or words preceding the word “means” is a label intended to ease referencing of claim elements and is not intended to convey a structural limitation. Such means-plus-function claims are intended to cover not only the structures described herein for performing the function and their structural equivalents, but also equivalent structures. For example, although a nail and a screw have different structures, they are equivalent structures since they both perform the function of fastening. Claims that do not use the word “means” are not intended to fall under 35 USC Sect. 112, paragraph 6. Signals are typically electronic signals, but may be optical signals such as can be carried over a fiber optic line.

The foregoing description of the embodiments of the invention has beer presented for the purposes of illustration and description. It is not intended to be exhaustive or to limit the invention to the precise form disclosed. Many modifications and variations are possible in light of the above teaching. It is intended that the scope o the invention be limited not by this detailed description, but rather by the claims appended hereto.

1. A stitched-image balancing method comprising:
receiving a plurality of images that having overlapping regions between adjacent images in the plurality of images;
ensuring that the plurality of images is in a luminance-color format having pixels each comprised of a luminance sub-layer having a Y value, a first color sub-layer having a U value, and a second color sub-layer having a V value, by converting pixels from the plurality of images into YUV-space pixels when the pixels from the plurality of images are not YUV-space pixels;
(1) selecting one of the plurality of images as a source image and another one of the plurality of images as a target image, wherein the source image has a source overlap region that overlaps with the target image, and the target image has a target overlap region that overlaps with the source image;
generating histograms for the source overlap region of the source image and for the target overlap region of the target image, wherein a source-Y histogram indicates a count of occurrences of each Y value for pixels in the source overlap region, and a target-Y histogram indicates counts of occurrences of Y values in the target overlap region;
generating a source-Y Cumulative Density Function (CDF) for the source-Y histogram and generating a target-Y CDF for the target-Y histogram;
combining the source-Y CDF and the target-Y CDF to generate a Y color transfer curve wherein a source Y value and a target Y value having a same value for the source-Y CDF and for the target-Y CDF are paired together as a point on the Y color transfer curve;
using a moving average to generate an averaged Y color transfer curve, wherein the averaged Y color transfer curve is smoother than the Y color transfer curve;
generating new Y values for pixels in the source image using the averaged Y color transfer curve;
replacing Y values in the source image with the new Y values; and
repeating from step (1) for other source and target images that overlap in the plurality of images until all overlapping images have been processed to form a stitched image containing the new Y values,
whereby the new Y values in the stitched image are generated using the averaged Y color transfer curve.

2. The stitched-image balancing method of claim 1 further comprising:
scaling the new Y values by a scaling ratio;
wherein the scaling ratio is a ratio of a maximum Y value to a maximum new Y value;
wherein replacing Y values in the source image with the new Y values comprises replacing Y values in the source image with the new Y values after scaling by the scaling ratio.

3. The stitched-image balancing method of claim 2 further comprising:
stitching the source image with the new Y values to the target image by aligning the source overlap region to the target overlap region and by blending pixels from the source and target images in the target overlap region and the source overlap region.

4. The stitched-image balancing method of claim 2 further comprising:
(2) generating histograms for the source image and for the target image, wherein a source-U histogram indicates counts of occurrences of U values in the source overlap region, and a source-V histogram indicates counts of occurrences of V values in the source overlap region, and a target-U histogram, and a target-V histogram indicate counts of occurrences of U and V values, respectively, in the target overlap region;
generating an averaged source-U histogram by averaging occurrence counts from the source-U histogram;
generating an averaged source-V histogram by averaging occurrence counts from the source-V histogram;
generating an averaged target-U histogram by averaging occurrence counts from the target-U histogram;
generating an averaged target-V histogram by averaging occurrence counts from the target-V histogram;
generating a source-U CDF from the averaged source-U histogram;
generating a source-V CDF from the averaged source-V histogram;
generating a target-U CDF from the averaged target-U histogram;
generating a target-V CDF from the averaged target-V histogram;
combining the source-U CDF and the target-U CDF to generate a U color transfer curve wherein a source U value and a target U value having a same value for the source-U CDF and for the target-U CDF are paired together as a point on the U color transfer curve;
combining the source-V CDF and the target-V CDF to generate a V color transfer curve wherein a source V value and a target V value having a same value for the source-V CDF and for the target V-CDF are paired together as a point on the V color transfer curve;
generating new U values for pixels in the source image using the U color transfer curve;
generating new V values for pixels in the source image using the V color transfer curve;
replacing U values in the source image with the new U values; and
replacing V values in the source image with the new V values;
repeating from step (2) for other source and target images that overlap in the plurality of images until all overlapping images have been processed to form the stitched image containing the new U values and the new V values,
wherein averaged histograms are used to generate the new U values and the new V values, and the averaged Y color transfer curve is used to generate the new Y values,
wherein U, V processes average histograms before CDF generation while a Y process averages a Y color transfer curve after CDF generation.

5. The stitched-image balancing method of claim 4 further comprising:
wherein a CDF indicates a sum of counts of occurrences from a minimum sub-layer value to a current sub-layer value, where the CDF increases from the minimum sub-layer value to a maximum sub-layer value as count occurrences are accumulated into the CDF.

6. The stitched-image balancing method of claim 4 wherein the Y color transfer curve has a concave shape with an abrupt bend when the source overlap region is brighter than the target overlap region;
wherein the averaged Y color transfer curve has a concave shape without the abrupt bend when the source overlap region is brighter than the target overlap region;
wherein visual bright-to-dark artifacts in the source image are otherwise created when the Y color transfer curve with the abrupt bend is used without averaging to generate the new Y values, wherein these visual bright-to-dark artifacts are avoided when the averaged Y color transfer curve is used to generate the new Y values;
wherein the visual bright-to-dark artifacts in the source image are not created when using the averaged Y color transfer curve.

7. The stitched-image balancing method of claim 4 wherein the Y color transfer curve has a convex shape with a flat region when the source overlap region is darker than the target overlap region;
wherein the averaged Y color transfer curve has a convex shape without the flat region when the source overlap region is darker than the target overlap region;
wherein saturation of the Y values occurs in the flat region, where loss of detail occurs;
wherein averaging to form the averaged Y color transfer curve causes the flat region to have a slope and not be a flat region with saturation;
wherein visual loss of detail in the source image are otherwise created when the Y color transfer curve with the flat region is used without averaging to generate the new Y values, where visual loss of detail is avoided when the averaged Y color transfer curve is used to generate the new Y values;
wherein dark-to-bright loss of detail in the source image is avoided by using the averaged Y color transfer curve.

8. The stitched-image balancing method of claim 3 further comprising:
dividing the stitched image into blocks;
calculating a sum-of-the-absolute difference (SAD) for a plurality of sub-blocks within a block for all blocks;
finding a maximum SAD that is a maximum of the SAD's for the plurality of sub-blocks with each block;
comparing the maximum SAD to a threshold;
when the maximum SAD is above the threshold, assigning the block to a first group;
when the maximum SAD is below the threshold, assigning the block to a second group;
executing a sharpening operation on each block in the first group using a first sharpening parameter value;
executing a sharpening operation on each block in the second group using a second sharpening parameter value;
wherein images are sharpened together after stitching images together into the stitched image;
wherein images in the stitched image are sharpened together in groups determined by comparison to the threshold.

9. The stitched-image balancing method of claim 3 further comprising:
dividing the stitched image into blocks;
calculating a sum-of-the-absolute difference (SAD) for a plurality of sub-blocks within a block for all blocks;
finding a maximum SAD that is a maximum of the SAD's for the plurality of sub-blocks with each block;
comparing the maximum SAD to a first threshold and to a second threshold;
when the maximum SAD is above the first threshold, assigning the block to a first group;
when the maximum SAD is below the first threshold, and above the second threshold, assigning the block to a second group;
when the maximum SAD is below the second threshold, assigning the block to a third group;
executing a sharpening operation on each block in the first group using a first sharpening parameter value;
executing a sharpening operation on each block in the second group using a second sharpening parameter value;
executing a sharpening operation on each block in the third group using a third sharpening parameter value;
wherein images are sharpened together after stitching images together into the stitched image;
wherein images in the stitched image are sharpened together in groups determined by comparison to multiple thresholds.

10. The stitched-image balancing method of claim 3 wherein the stitched image is a panorama image comprising at least 6 images in the plurality of images and forming a continuous loop of 360 degrees.

11. A panorama generator comprising:
an image loader that loads images that overlap to form at least part of a panoramic image;
wherein pixels in images comprise sub-layers including a Y value that indicates a pixel brightness and U and V values that indicate a pixel color;
an images selector that selects one image loaded by the image loader as a source image, and selects another image loaded by the image loader as a target image, wherein the source image and the target image partially overlap;
an overlap detector that identifies pixels in a source overlap region in the source image and in a target overlap region in the target image, wherein the source overlap region and the target overlap region contain pixels captured from a same visual object visible in both the source image and the target image;
a histogram generator that generates histograms of sub-layer values for the source overlap region and for the target overlap region;
a Y-channel process that constructs an averaged Y color transfer curve that is averaged from a Y color transfer curve that is generated from the histograms of sub-layer values that are Y values;
a U,V-channel process that constructs a U color transfer curve and a V color transfer curve by generating an averaged source-U histogram and an averaged source-V histogram for the source overlap region, and by generating an averaged target-U histogram and an averaged target-V histogram for the target overlap region;
a luminosity transferer that uses the averaged Y color transfer curve to convert Y values from the source image into new Y values that over-write the Y values in the source image;
a color transferer that uses the U color transfer curve to convert U values from the source image into new U values that over-write the U values in the source image, and that uses the V color transfer curve to convert V values from the source image into new V values that over-write the V values in the source image;
a panorama memory for storing the panoramic image; and
an image stitcher that writes the source image with the new Y values, the new U values, and the new V values into the panorama memory;
whereby the new Y values are generated using the averaged Y color transfer curve, while the new U and V values are generated using averaged histograms.

12. The panorama generator of claim 11 further comprising:
a luminosity scaler that multiplies the new Y values by a scaling ratio;
wherein the scaling ratio is a ratio of a maximum Y value to a maximum new Y value;
wherein the luminosity transferer replaces Y values in the source image with the new Y values after scaling by the scaling ratio.

13. The panorama generator of claim 12 wherein the Y-channel process further comprises:
a Y Cumulative Density Function (CDF) generator that receives from the histogram generator a source-Y histogram and a target-Y histogram, the Y CDF generator generates a source-Y CDF that accumulates counts of Y values from a minimum Y value to a current Y value for pixels in the source overlap region, and generates a target-Y CDF that accumulates counts of Y values from a minimum Y value to a current Y value for pixels in the target overlap region;
a Y color transfer curve generator that generates the Y color transfer curve by combining the source-Y CDF and the target-Y CDF to generate the Y color transfer curve wherein a source Y value and a target Y value having a same value for the source-Y CDF and for the target-Y CDF are paired together as a point on the Y color transfer curve; and
a curve averager that receives the Y color transfer curve as an input and averages adjacent points on the Y color transfer curve to generate averaged points on the averaged Y color transfer curve.

14. The panorama generator of claim 13 wherein the U,V-channel process further comprises:
a Cumulative Density Function (CDF) generator that receives the averaged source-U histogram as an input and generates a source-U CDF that accumulates counts of U values from a minimum U value to a current U value; and also similarly generates a source-V CDF from the averaged source-V histogram, a target-U CDF from the averaged target-U histogram, and a target-V CDF from the averaged target-V histogram,
whereby averaged histograms are used to generate CDF's for color sub-layers.

15. The panorama generator of claim 14 wherein the U,V-channel process further comprises:
a histogram averager that receives from the histogram generator a source-U histogram, a source-V histogram, a target-U histogram, and a target-V histogram, the histogram averager generating the averaged source-U histogram by averaging count values on the source-U histogram, and generating the averaged source-V histogram, the averaged target-U histogram, and the averaged target-V histogram by averaging count values from the source-V histogram, the target-U histogram, and the target-V histogram, respectively.

16. The panorama generator of claim 15 wherein the U,V-channel process further comprises:
a U color transfer curve generator that generates the U color transfer curve by combining the source-U CDF and the target-U CDF to generate the U color transfer curve wherein a source U value and a target U value having a same value for the source-U CDF and for the target-U CDF are paired together as a point on the U color transfer curve;
a V color transfer curve generator that generates the V color transfer curve by combining the source-V CDF and the target-V CDF to generate a V color transfer curve wherein a source V value and a target V value having a same value for the source-V CDF and for the target-V CDF are paired together as a point on the V color transfer curve.

17. The panorama generator of claim 11 further comprising:
a format converter that converts pixels loaded by the image loader into YUV format, wherein a Y value indicates a pixel brightness and U and V values indicate a pixel color.

18. The panorama generator of claim 11 further comprising:
a sharpening balancer that reads blocks of pixels from the panoramic image in the panorama memory, compares a measure of sharpness for each block to a threshold to segregate blocks into sharpening groups, and sharpens blocks in each sharpening group using a different sharpening parameter for each sharpening group,
whereby blocks across all images in the panoramic image are grouped together into groups for sharpening.

19. An image-stitching luminance balancer comprising:
input means for receiving a plurality of images that having overlapping regions between adjacent images in the plurality of images;
format means for ensuring that the plurality of images is in a luminance-color format having pixels comprised of a luminance sub-layer having a Y value, a first color sub-layer having a U value, and a second color sub-layer having a V value, by converting pixels from the plurality of images into YUV pixels when the pixels from the plurality of images are not YUV pixels;
selection means for selecting one of the plurality of images as a source image and another one of the plurality of images as a target image, wherein the source image has a source overlap region that overlaps with the target image, and the target image has a target overlap region that overlaps with the source image;
histogram generating means for generating histograms for the source image and for the target image, wherein a source-Y histogram indicates a count of occurrences of each Y value for pixels in the source overlap region, and a target-Y histogram indicates counts of occurrences of Y values in the target overlap region;
function means for generating a source Y Cumulative Density Function (CDF) for the source-Y histogram and generating a target-Y CDF for the target-Y histogram;
curve generating means for combining the source-Y CDF and the target-Y CDF to generate a Y color transfer curve wherein a source Y value and a target Y value having a same value for the source-Y CDF and for the target-Y CDF are paired together as a point on the Y color transfer curve;
averaging means for using a moving average to generate an averaged Y color transfer curve, wherein the averaged Y color transfer curve is smoother than the Y color transfer curve;
transfer means for generating preliminary Y values for pixels in the source image using the averaged Y color transfer curve
scaling the preliminary Y values by a scaling ratio to generate new Y values;
wherein the scaling ratio is a ratio of a maximum Y value to a maximum preliminary Y value;
update means for replacing Y values in the source image with the new Y values; and
loop means for repeating in a loop from the selection means for other source and target images that overlap in the plurality of images until all overlapping images have been processed to form a stitched image containing the new Y values,
whereby the new Y values in the stitched image are generated using the averaged Y color transfer curve.

20. The image-stitching luminance balancer of claim 19 further comprising:
second histogram generating means for generating histograms for the source image and for the target image, wherein a source-U histogram indicates counts of occurrences of U values in the source overlap region, and a source-V histogram indicates counts of occurrences of V values in the source overlap region, and a target-U histogram, and a target-V histogram indicate counts of occurrences of U and V values, respectively, in the target overlap region;
means for generating an averaged source-U histogram by averaging occurrence counts from the source-U histogram;
means for generating an averaged source-V histogram by averaging occurrence counts from the source-V histogram;
means for generating an averaged target-U histogram by averaging occurrence counts from the target-U histogram;
means for generating an averaged target-V histogram by averaging occurrence counts from the target-V histogram;
means for generating a source-U CDF from the averaged source-U histogram;
means for generating a source-V CDF from the averaged source-V histogram;
means for generating a target-U CDF from the averaged target-U histogram;
means for generating a target-V CDF from the averaged target-V histogram;
means for combining the source-U CDF and the target-U CDF to generate a U color transfer curve wherein a source U value and a target U value having a same value for the source-U CDF and for the target-U CDF are paired together as a point on the U color transfer curve;
means for combining the source-V CDF and the target-V CDF to generate a V color transfer curve wherein a source V value and a target V value having a same value for the source-V CDF and for the target V-CDF are paired together as a point on the V color transfer curve;
means for generating new U values for pixels in the source image using the U color transfer curve;
means for generating new V values for pixels in the source image using the V color transfer curve;
means for replacing U values in the source image with the new U values;
means for replacing V values in the source image with the new V values; and
means for repeating the second histogram generating means for other source and target images that overlap in the plurality of images until all overlapping images have been processed to form the stitched image containing the new U values and the new V values,
wherein averaged histograms are used to generate the new U values and the new V values, and the averaged Y color transfer curve is used to generate the new Y values,
wherein U, V processes average histograms before CDF generation while a Y process averages a Y color transfer curve after CDF generation;
wherein a CDF indicates a sum of counts of occurrences from a minimum sub-layer value to a current sub-layer value, where the CDF increases from the minimum sub-layer value to a maximum sub-layer value as count occurrences are accumulated into the CDF.
